(19) United States
(12) Patent Application Publication
(10) Pub. No.: US 2003/0202676 A1
(43) Pub. Date: Oct. 30, 2003

(54) Composite damper of loudspeaker

(76) Inventor: Hiroshi Ohara, Taipei (TW)

Correspondence Address: BIRCH STEWART KOLASCH & BIRCH, PO BOX 747, FALLS CHURCH, VA, 22040-0747, US

(21) Appl. No.: 10/134,464

(22) Filed: Apr. 30, 2002

(51) Int. Cl. H04R 1/00; H04R 9/06; H04R 11/02

(52) U.S. Cl. 381/404; 381/399

(57) ABSTRACT

A speaker damper includes two layers formed by weaving threads to sandwich conductors therebetween. The conductors are to be connected to and driving a voice coil of the speaker. Adhesive material that is applied between the layers fixes the layers and the conductors together. The composite film is then subject to further processing to form a wavy configuration having a number of concentric troughs and ridges. A central bore is defined in the composite film for receiving and retaining the voice coil. The conductors that are sandwiched between the layers is fully protected and conveniently retained. No sewing is required and thus potential damage caused by sewing is completely eliminated.

### FIELD OF THE INVENTION

The present invention relates generally to a speaker damper that is formed by weaving threads or fibers as a flexible sheet for supporting a voice coil of the speaker, and in particular to a damper made of a composite film with conductors sandwiched between layers of the film for protection purposes.

### BACKGROUND OF THE INVENTION

Dampers made by weaving threads as a flexible sheet are widely used in loudspeakers for supporting voice coils of the speakers. The flexible sheet that makes the damper is commonly formed with a wavy configuration for flexibility. In other words, the damper comprises a ring like member having a number of annular and concentric troughs and ridges alternating each other. A central bore is defined in the ring member and substantially concentric with the troughs and the ridges for receiving and retaining the voice coil.

The speaker voice coil is driven by electric signals transmitted through conductors, such as wires, connected to the voice coil. Due to the vibration caused by the operation of the voice coil, the conductors that are connected to the voice coil are subject to severe vibration. Under certain conditions, the conductors may get broken.

To address such an issue, some of the manufacturers integrate the conductors with the woven sheet of the damper by weaving the conductor with the threads that form the damper. This effectively secures the conductors and reduces the magnitude of the vibration that the conductors are subject to. However, since the sheet is subject to a molding operation to form the wavy configuration, the conductors may get damaged during the molding operation.

Another solution for the vibration of the conductors is to additionally attach the conductors to the damper by sewing as shown in FIGS. 1 and 1A of the attached drawings. This alleviates the problems at the expense of additional costs for sewing. Further, sewing may cause damage to the damper itself.

Thus, it is desired to have a speaker damper for overcoming the above problems.

### SUMMARY OF THE INVENTION

An object of the present invention is to provide a damper having a composite structure comprising two layers with conductors sandwiched therebetween for carrying and protecting the conductors.

Another object of the present invention is to provide a damper having conductors integrated therein without causing damages to the damper itself.

To achieve the above objects, in accordance with the present invention, there is provided a speaker damper made of a composite film comprising at least two layers formed by weaving threads to sandwich conductors therebetween. The conductors are to be connected to and driving a voice coil of the speaker. Adhesive material that is applied between the layers fixes the layers and the conductors together. The composite film is then subject to a molding operation to form a wavy configuration. A central bore is defined in the composite film for receiving and retaining the voice coil. The conductors that are sandwiched between the layers is fully protected and conveniently retained. No sewing is required and thus potential damage caused by sewing is completely eliminated.

### BRIEF DESCRIPTION OF THE DRAWINGS

The present invention will be apparent to those skilled in the art by reading the following description of preferred embodiments thereof, with reference to the attached drawings, in which:

FIG. 1 is a perspective view of a conventional speaker damper having a wavy configuration;

FIG. 1A is an enlarged view of encircled portion 1A of FIG. 1;

FIG. 2 is a perspective view of a speaker damper constructed in accordance with the present invention;

FIG. 3 is an exploded view of the speaker damper of the present invention;

FIG. 4 is a perspective view of the speaker damper with a portion removed to show inside details,

FIG. 4A is an enlarged view of encircled portion 4A of FIG. 4;

FIG. 5 is a perspective view of a speaker damper constructed in accordance with another embodiment of the present invention;

FIG. 6 is an exploded view of a speaker damper constructed in accordance with a further embodiment of the present invention; and

FIG. 6A is an enlarged view of encircled portion 6A of FIG. 6.

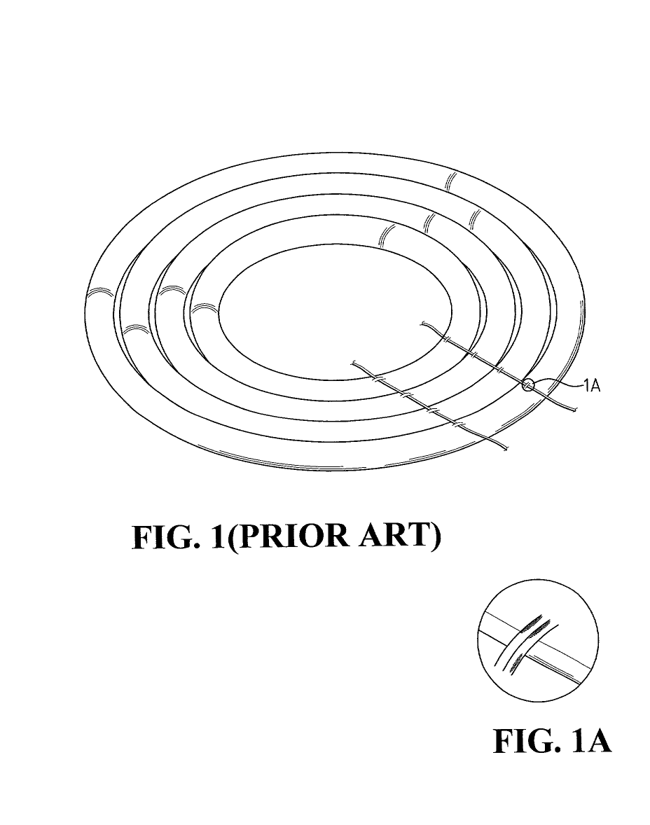

### DETAILED DESCRIPTION OF THE INVENTION

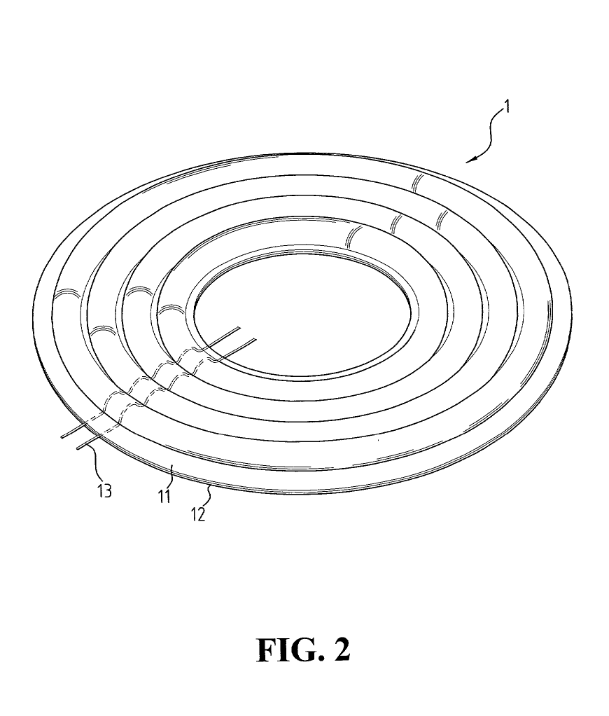

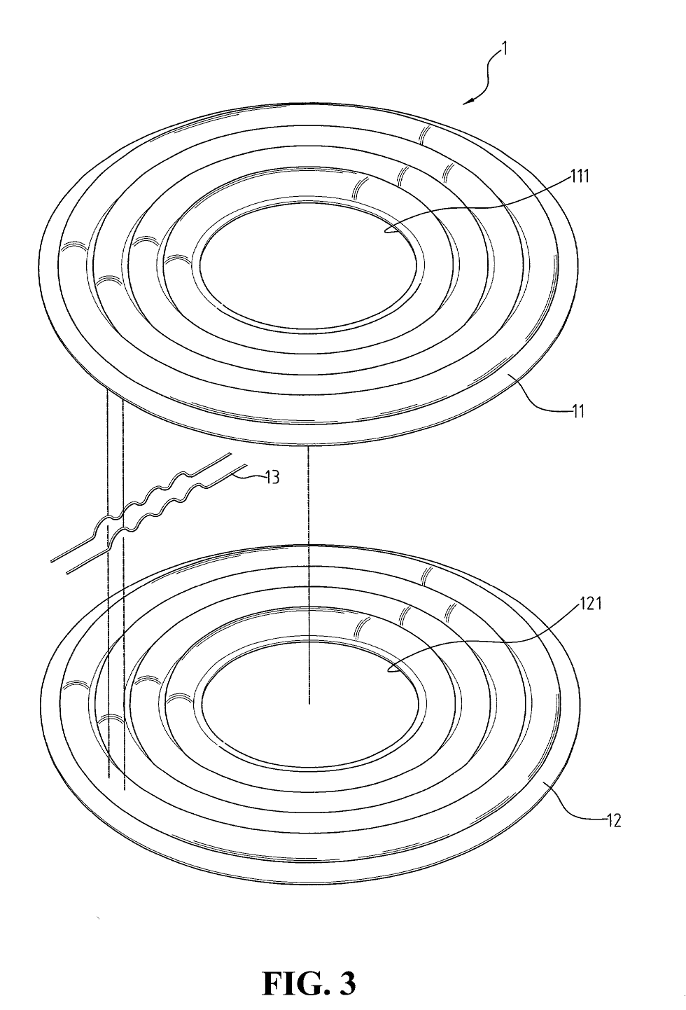

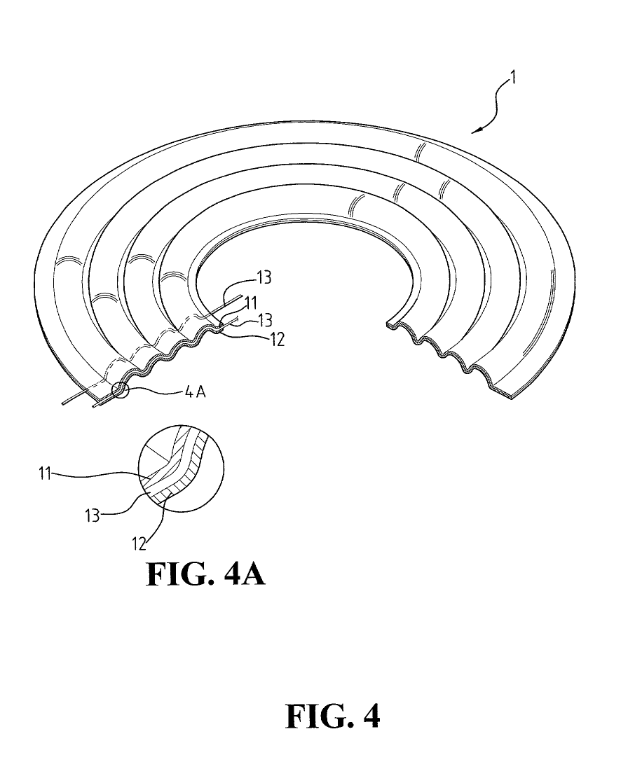

With reference to the drawings and in particular to FIGS. 2-4 and 4A, a speaker damper constructed in accordance with a preferred embodiment of the present invention, generally designated with reference numeral 1, comprises a first layer 11 and a second layer 12 overlapping and attached to each other with a plurality of conductors 13 (such as two conductors) sandwiched therebetween. Each of the layers 11, 12 is in general a ring having a wavy major surface, comprising a number of concentric troughs and ridges (both not labeled) around a central bore 111, 121. Opposite ends of the conductors 13 extend beyond inner and outer circumferences of the damper 1. The layers 11, 12 are made by suitably weaving threads as a sheet. Further processing is then conducted to form the wavy configuration wherein the layers 11, 12 with the conductors 13 positioned therebetween are subject to heat and pressure by means of suitable mould and driving means to form a single composite sheet having a wavy cross section. The conductors 13 are made of a deformable metal to avoid unnecessary damage thereto during the heating and pressing process.

Adhesive material is applied between the layers 11, 12 when they are subject to heat and pressure to securely fix the layers 11, 12 together. Alternatively, the layer 11, 12 themselves contain adhesive materials therein. For example, the layers 11, 12 may be impregnated with liquid adhesive that is cured after being heated or otherwise processed.

Sandwiching the conductors 13 between the layers 11, 12 provides excellent protection to the conductors 13 when the voice coil is energized to vibrate speaker driver. Break of the conductors 13 caused by vibration is thus alleviated. Further, since no sewing is required to attach the conductors 13 to the damper, damage of the damper caused by sewing needle can be completely eliminated.

Preferably, an additional coating or layer is formed on an outside, major surface of each layer 11, 12 to enhance protection and performance of the damper 1.

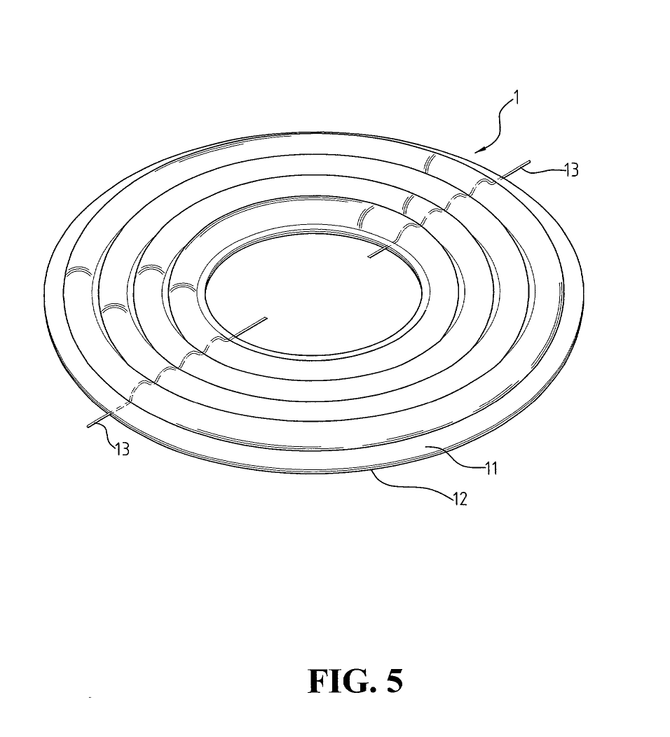

In the embodiment illustrated in FIGS. 2-4, the conductors 13 are arranged to be adjacent to and substantially parallel to each other. However, it is apparent to those having ordinary to arrange the conductors 13 in different ways. FIG. 5 shows another embodiment of the present invention wherein the conductors 13 are arranged to be substantially collinear with each other along a diameter of the damper 1. If desired, the conductors 13 can be angularly spaced from each other at any angles, such as 90 degrees.

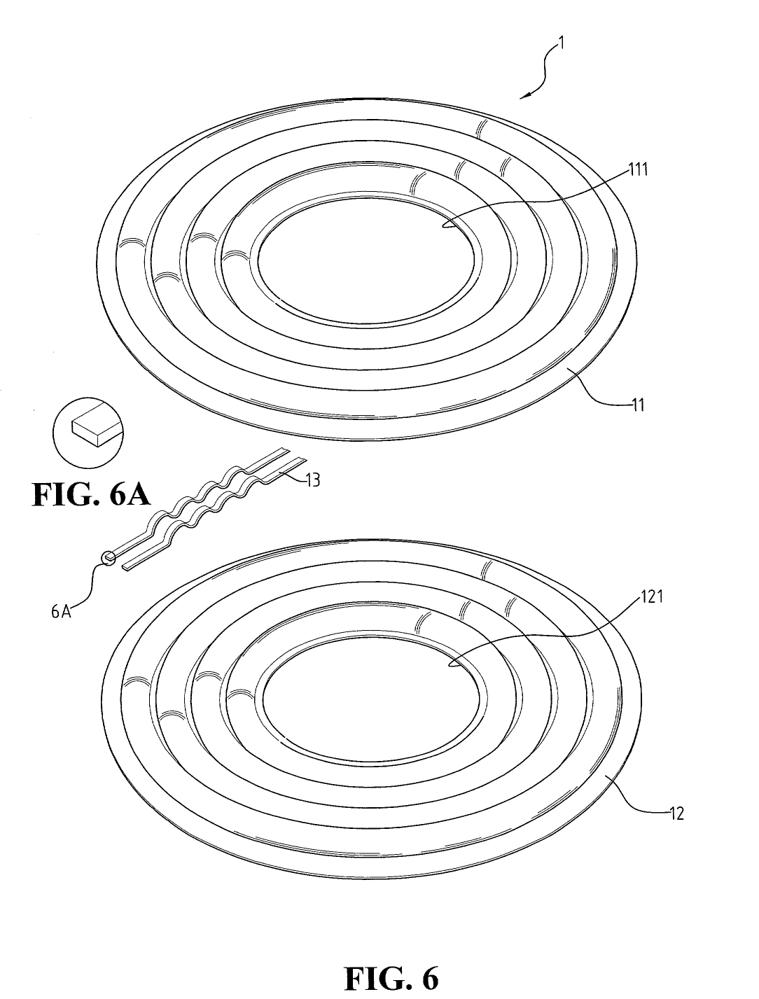

Although in the previous embodiments, the conductors 13 are in general round wires having a circular cross section, the conductors 13 can be made flat, such as those shown in a further embodiment of the present invention illustrated in FIGS. 6 and 6A. The flat configuration makes it easy to firmly secure the conductors 13 between the layers 11, 12.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A speaker damper comprising:
first and second layers overlapping and secured together, defining a central bore forming an inner circumference of t he damper for receiving and retaining a voice coil of a speaker, the first and second layers having an outer circumference; and conductors sandwiched between t he first and second layers with ends extending beyond the inner and outer circumferences of the layers.

2. The speaker damper as claimed in claim 1, wherein the layers are formed by weaving threads as a sheet.

3. The speaker damper as claimed in claim 1, wherein the conductors have a round cross section.

4. The speaker damper as claimed in claim 1, wherein the conductors have a flat cross section.

5. The speaker damper as claimed in claim 1, wherein two conductors are sandwiched between the layers.

6. The speaker damper as claim ed in claim 1, wherein the layers are made wavy comprising a number of concentric troughs and ridges surrounding t he central bore.

7. The speaker damper as claimed in claim 1, wherein an adhesive material is applied between the layers for securing the layers together.

8. The speaker damper as claimed in claim 1, wherein the layers are impregnated with an adhesive for securing the layers together.

9. The speaker damper as claimed in claim 1, wherein the conductors are adjacent and substantially parallel to each other.

10. The speaker damper as claimed in claim 1, wherein the conductors are angularly spaced from each other at an angle.

11. The speaker damper as claimed in claim 10, wherein two conductors are sandwiched between the layers and spaced from each other an angle of 180 degrees.
